(19) United States
(12) Patent Application Publication
(10) Pub. No.: US 2026/0023220 A1
(43) Pub. Date: Jan. 22, 2026

(54) INVERSELY DESIGNED TWO-LAYER PHOTONIC GRATING COUPLER

(71) Applicant: X Development LLC, Mountain View, CA (US)

(72) Inventors: Jian Guan, Newark, CA (US); Yang Meng, Santa Clara, CA (US); Philip Watson, Felton, CA (US)

(21) Appl. No.: 18/780,025

(22) Filed: Jul. 22, 2024

(51) Int. Cl. G02B 6/34; G02B 6/27

(52) U.S. Cl. CPC G02B 6/34; G02B 6/2726; G02B 6/2773

(57) ABSTRACT

A photonic grating coupler includes at least one waveguide port and a multi-layer material stack. The multi-layer material stack includes a first mixed material layer forming an upper inverse design region in which an upper grating pattern is disposed and a second mixed material layer disposed below the first mixed material layer. The second mixed material layer forms a lower inverse design region in which a lower grating pattern is disposed. The first and second waveguide ports physically abut to and extend from the second mix material layer and the upper and lower grating patterns are structured to collectively couple an optical signal incident on the photonic grating coupler from above the first mixed material layer into the at least one waveguide port.

### TECHNICAL FIELD

This disclosure relates generally to inversely designed grating couplers, and in particular but not exclusively, relates to polarization splitting grating couplers.

### BACKGROUND INFORMATION

Artificial intelligence (AI) and machine learning (ML) applications are expected to place high demands on the data bandwidth of future XPUs (e.g., central processing units, graphic processing units, tensor processing units, etc.). In fact, data bandwidth is expected to be the bottleneck for future XPU development. In particular, board-to-board and chip-to-chip interconnects will need to support ever increasing bandwidths. Optical interconnects promise to satisfy this increasing bandwidth need.

Grating couplers are a fundamental building block for high-speed optical interconnects as they enable optical signals to be routed on and off photonic integrated circuits (PICs). Conventional grating couplers are designed based on a one-dimensional (1D) periodic structure using either fundamental grating theory, or an inverse design algorithm, and then extruding to a two-dimensional (2D) design in a single material layer. The resultant devices typically include an adiabatic taper structure, grating structure, and supporting waveguide. However, the extruded 2D, single layer nature of these conventional designs have limited performance and often must sacrifice either bandwidth or coupling efficiency to a limiting extent.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A is a perspective view illustration of an inversely designed two-layer grating coupler, in accordance with an embodiment of the disclosure.

FIG. 1B is a cross-sectional view illustration of a material layer stack-up for a two-layer grating coupler, in accordance with an embodiment of the disclosure.

FIGS. 2A and 2B illustrate the inversely designed upper and lower grating patterns for the two-layer grating coupler, in accordance with an embodiment of the disclosure.

FIG. 3 is an o-band transmission and reflection plot for the two-layer grating coupler, in accordance with an embodiment of the disclosure.

FIG. 4A is a perspective view illustration of an inversely designed two-layer polarization splitting grating coupler, in accordance with an embodiment of the disclosure.

FIG. 4B is a cross-sectional view illustration of a material layer stack-up for the two-layer polarization splitting grating coupler, in accordance with an embodiment of the disclosure.

FIG. 5A illustrates the inversely designed upper grating pattern for the two-layer polarization splitting grating coupler, in accordance with an embodiment of the disclosure.

FIG. 5B illustrates the inversely designed lower grating pattern for the two-layer polarization splitting grating coupler, in accordance with an embodiment of the disclosure.

FIG. 5C illustrates functional features of the upper and lower grating patterns for the two-layer polarization splitting grating coupler, in accordance with an embodiment of the disclosure.

FIG. 6 is a perspective view illustration of an inversely designed two-layer polarization splitting grating coupler, in accordance with another embodiment of the disclosure.

FIG. 7A illustrates a demonstrative simulated environment for

simulating the operation of a photonic grating coupler under design, in accordance with an embodiment of the disclosure.

FIG. 7B illustrates an operational simulation of a photonic grating coupler, in accordance with an embodiment of the disclosure.

FIG. 7C illustrates an adjoint simulation (backpropagation) of a performance loss error through the simulated environment including the photonic grating coupler, in accordance with an embodiment of the disclosure.

FIG. 8A is a flow chart illustrating example time steps for operational and adjoint simulations used to inversely design a photonic grating coupler, in accordance with an embodiment of the disclosure.

FIG. 8B is a flow chart illustrating a relationship between an operational simulation and the adjoint simulation (backpropagation), in accordance with an embodiment of the disclosure.

### DETAILED DESCRIPTION

Embodiments of systems, apparatuses, and methods of operation of inversely designed two-layer photonic grating couplers, including a polarization splitting grating coupler, are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of the photonic grating couplers described herein provide performance specifications that exceed those of conventional grating couplers by using inverse design techniques to design two distinct two-dimensional (2D) grating patterns that are stacked on top of each other. Simulation results demonstrate that this multi-layer 2D grating structure can achieve broad bandwidth with increased coupling efficiency, and greater coupling angle flexibility when compared to conventional grating coupler designs.

Conventionally, when an optic fiber is coupled into a photonic integrated circuit (PIC) through an edge coupler, different fiber polarizations will excite different waveguide modes such as transverse-electric (TE), transverse-magnetic (TM), or a mixture of both. As such, polarization beam splitters (PBS) or polarization rotating beam splitters (PRBS) are typically used to select or enhance a certain mode. When the optic fiber is coupled into a PIC through a grating coupler, the coupling loss is also polarization sensitive. Embodiments described herein leverage the multi-layer 2D grating pattern to combine polarization selectivity and/or polarization rotation functions into the grating coupler itself using inverse design techniques. Conventionally, these functions require the use of separate devices that each have their own associated losses (e.g., transmission loss, reflection loss, crosstalk loss, etc.). By combining these distinct functions into a single photonic device, the overall losses are reduced and the opportunities to design photonic devices that tradeoff efficiency, coupling angle, bandwidth, central wavelength, and polarization selectivity using inverse design are elevated. Additionally, the overall footprint of an integrated combination device can be reduced compared to linking distinct devices.

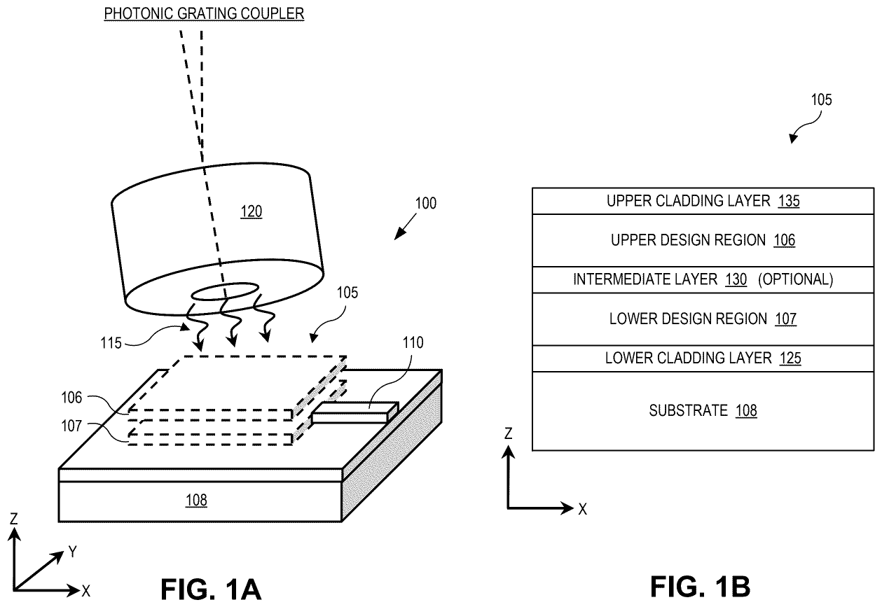

FIG. 1A is a perspective view illustration of an inversely designed two-layer grating coupler 100, in accordance with an embodiment of the disclosure. The illustrated embodiment of grating coupler 100 includes a multi-layer material stack 105 and at least one waveguide port 110. Multi-layer material stack 105 includes two distinct inversely designed grating patterns each formed into a corresponding one of upper design region 106 and lower design region 107. Photonic grating coupler 100 serves to couple optical signals on and off a photonic integrated circuit (PIC) or chip. In the illustrated embodiment, optical signals 115 output from optic fiber 120 are incident onto the topside of multi-layer material stack 105 and coupled into waveguide port 110 for guided transmission to other opto-electronic components also disposed on substrate 108 of the PIC or otherwise integrated into a common chip. Accordingly, photonic grating coupler 100 may be integrated into a PIC for receiving optical signals 115 onto the chip, and in some embodiments, may operate in reverse to export optical signals off-chip. Accordingly, photonic grating coupler 100 may be bidirectional or unidirectional (for importing or exporting optical signals 115) and waveguide port 110 may operate as an input waveguide port, an output waveguide port, or both an input and output waveguide port.

FIG. 1B is a cross-sectional view illustration of multi-layer material stack 105, in accordance with an embodiment of the disclosure. The illustrated embodiment of multi-layer material stack 105 includes substrate 108, a lower cladding layer 125, lower design region 107, an optional intermediate layer 130, upper design region 106, and upper cladding layer 135. Upper and lower design regions 106, 107 are mixed material layers each forming a grating pattern that are structured to collectively couple optical signal 115 incident on photonic grating coupler 100 from above into waveguide port 110 for output to other on-chip photonic devices. The mixed materials are optically transmissive materials having different refractive indexes that may be patterned to form diffraction gratings in the respective design regions. For example, upper and lower design regions 106, 107 may be formed from semiconductor materials and patterned into diffraction gratings using conventional semiconductor fabrication techniques. Upper and lower design regions 106, 107 may be formed from the same set of materials or different materials. For example, in one embodiment, upper design region 106 includes silicon and polysilicon while lower design region 107 includes silicon and silicon oxide (e.g., Si and SiO2). Of course, other material combinations may be used. The upper and lower cladding layers 135 and 125 include a lower refractive index material, such as silicon oxide, to provide beam confinement within the design regions. The cladding layers may typically range from less than a micron thick (e.g., 600 nm) to a few microns thick (e.g., 2 or 3 micron). In one embodiment, substrate 108 is a silicon substrate and multi-layer material stack 105 is a silicon-on-insulator (SOI) based photonic device.

In the illustrated embodiment, an optional intermediate layer 130 is included. Intermediate layer 130 is a passivation layer and an artifact of manufacture. In one embodiment, intermediate layer 130 is a multi-layer structure including SiO2 (5 nm thick) and Si3N4 (12 nm thick). Of course, intermediate layer 130 may be fabricated from other materials having other thickness, or even entirely omitted, dependent upon the fabrication process.

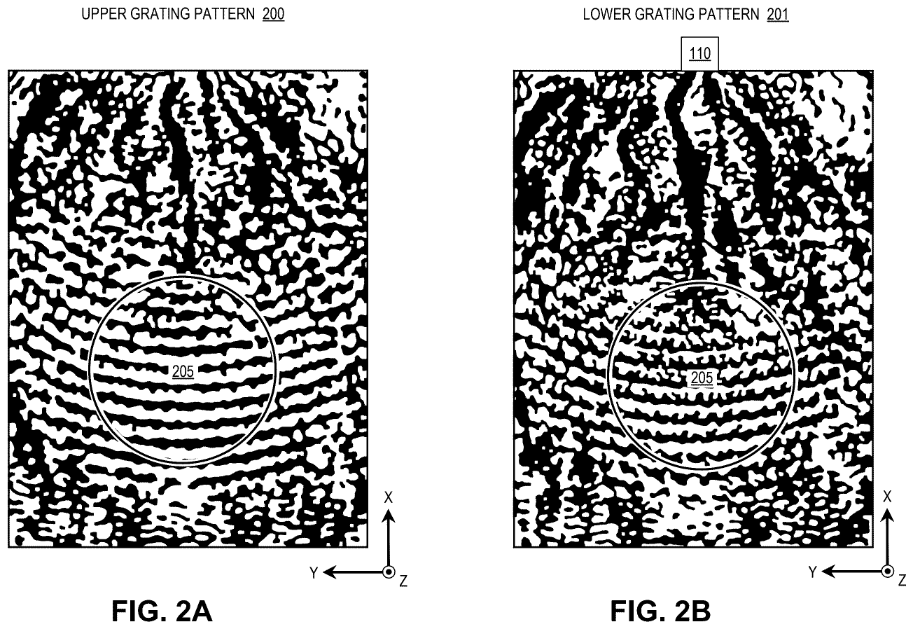

FIGS. 2A and 2B illustrate upper and lower grating patterns 200 and 201, in accordance with an embodiment of the disclosure. Upper and lower grating patterns 200 and 201 represent example grating patterns that may be formed into upper and lower design regions 106 and 107, respectively, for forming photonic grating coupler 100. Upper and lower grating patterns 200 and 201 are inversely designed patterns derived from an iterative minimization of a loss function used during the inverse design methodology.

The illustrated embodiment of upper and lower grating patterns 200 and 201 each include a central region 205 for aligning with the incident beam pattern of optical signal 115 (illustrated as a circle in central region 205). Central region 205 has a concentric curve pattern where a diffraction grating predominates while the surrounding peripheral region has a more chaos-like pattern. The portion of lower grating pattern 201 adjacent to waveguide port 110 includes irregularly shaped channels of the higher index material (black colored regions) that provide beam confinement to gather the optical signal into waveguide port 110. While the upper and lower grating patterns 200 and 201 resemble each other, it is notable that lower grating pattern 201 has more irregularly jagged features compared to upper grating pattern 200. In one embodiment, lower grating pattern 201 has a smaller minimum feature size (e.g., 80-90 nm) than upper grating pattern 200 (e.g., 100-104 nm). In one embodiment, upper grating pattern 200 is fabricated from polysilicon (black portions) and silicon oxide (white portions) while lower grating pattern 201 is fabricated from silicon (black portions) and silicon oxide (white portions). In one embodiment, upper and lower grating patterns 200 and 201 are 16 μm×12 μm, though other design region dimensions may be stipulated.

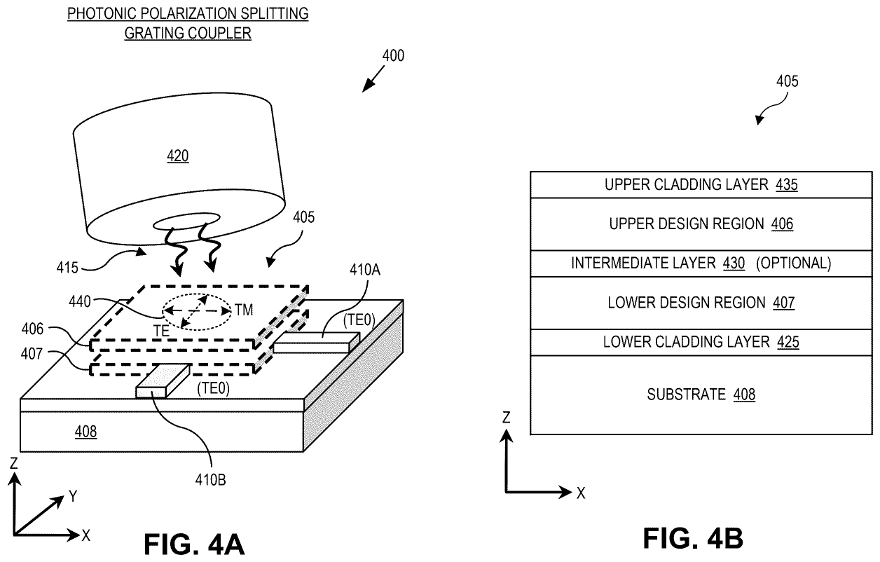

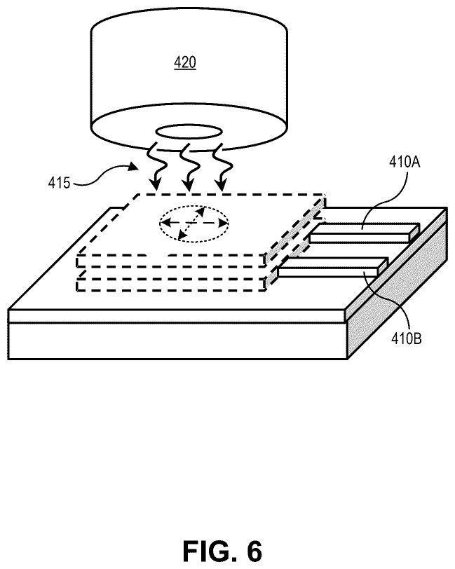

Upper and lower grating patterns 200 and 201 are formed in upper and lower design regions 106 and 107, which are design regions that are jointly optimized during an iterative inverse design process using a loss function. The loss function includes component functions representing a transmission loss, a reflection loss, and in some embodiments (when multiple output waveguide ports are included as with the embodiment of FIGS. 4A and 6) a crosstalk loss. The component functions are themselves defined as the difference between the simulated values for a particular inverse design iteration and the desired target values (see Eq. A below). The loss function, including the component functions, are stipulated in terms of the material parameters in the upper and lower design regions, incident angle for optical signal 115, wavelength(s) of optical signal 115, and even polarization/propagation mode and power of the output signal reaching waveguide port 110.

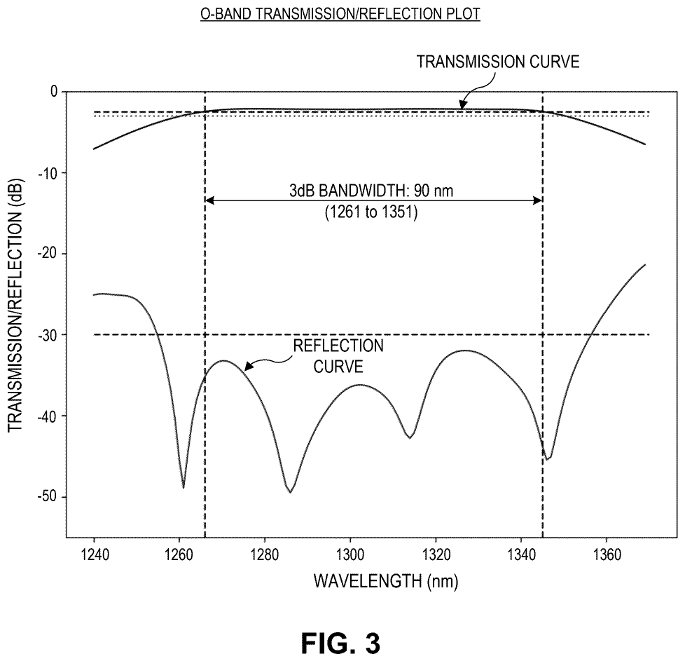

FIG. 3 is an o-band transmission and reflection plot for the two-layer photonic grating coupler 100 implemented using upper and lower grating patterns 200 and 201, in accordance with an embodiment of the disclosure. As illustrated, upper and lower grating patterns 200 and 201 were formed in upper and lower design regions 106 and 107 by selecting target parameters: 80 nm bandwidth centered at 1306 nm in the o-band (1260 nm to 1360 nm), a transmission loss of −2.5 dB, a reflection loss of −30 dB, and a 10 degree oblique incident Gaussian beam aligned with the center region 205 of upper design region 106. Of course, the target parameters may be customized for other bandwidths, other center wavelengths in other transmission bands (e.g., c-band 1530 nm to 1565 nm), and other incident angles (normal or oblique).

FIGS. 1A-3 describe an inversely designed photonic grating coupler having a single output port. In some scenarios it may be desirable to have multiple output ports for demultiplexing multi-mode/polarization optical signals. For example, optical signal 115 may include distinct communication channels multiplexed on transverse electric (TE) polarization modes and transverse magnetic (TM) polarization modes. For example, optic fiber 120 may propagate the fundamental spatial mode TEO on the TE polarization and the fundamental spatial mode TMO on the TM polarization. Of course, optic fiber 120 may itself be a multi-mode fiber capable of carrying higher order spatial modes.

FIG. 4A is a perspective view illustration of an inversely designed two-layer polarization splitting grating coupler (PSGC) 400, in accordance with an embodiment of the disclosure. The illustrated embodiment of PSGC 400 includes a multi-layer material stack 405 and at least two waveguide ports 410A and 410B. Multi-layer material stack 405 includes two distinct inversely designed grating patterns each formed into a corresponding one of upper design region 406 and lower design region 407. PSGC 400 serves to couple optical signals having multiple polarizations/modes on and off a PIC or chip. In the illustrated embodiment, optical signals 415 output from optic fiber 420 are incident onto the topside of multi-layer material stack 405 and coupled into waveguide ports 410 for guided transmission to other opto-electronic components also disposed on substrate 408 of the PIC. Accordingly, PSGC 400 may be integrated into a PIC for receiving optical signals 415 onto the chip, and in some embodiments, may operate in reverse to export optical signals off-chip. Accordingly, PSGC 400 may be bidirectional or unidirectional (for importing or exporting optical signals 415) and waveguide ports 410 may operate as input waveguide ports, output waveguide ports, or both input and output waveguide ports.

PSGC 400 is different from photonic grating coupler 100, illustrated in FIG. 1A, in that PSGC 400 includes polarization selective routing to its waveguide ports 410A and 410B, and in some embodiments, may also perform selective polarization rotation (e.g., TM→TE). For example, in the illustrated embodiment, a power majority of TE polarization mode components in optical signal 415 are routed to waveguide port 410A while a power majority of TM polarization mode components in optical signal 415 are routed to waveguide port 410B. In addition, the illustrated embodiment rotates the TMO mode component of optical signal 415 to a TEO mode component, which is spatially separated on waveguide port 410B from the TEO mode component on waveguide port 410A.

FIG. 4B is a cross-sectional view illustration of multi-layer material stack 405, in accordance with an embodiment of the disclosure. The illustrated embodiment of multi-layer material stack 405 includes substrate 408, a lower cladding layer 425, lower design region 407, an optional intermediate layer 430, upper design region 406, and upper cladding layer 435. Upper and lower design regions 406, 407 are mixed material layers for forming grating patterns that are structured to collectively couple optical signal 415 incident on PSGC 400 from above into waveguide ports 410A and 410B for output to other on-chip photonic devices. The material layers of multi-layer material stack 405, and the associated fabrication techniques, may be the same as those described above in connection with multi-layer material stack 105. However, the loss function used to derive the grating patterns formed in upper design region 406 and lower design region 407 is altered to reward the selective polarization splitting (and optional polarization rotation) functionality described above. In one embodiment, the loss function for PSGC 400 specifies four virtual/simulation ports (as opposed to just two for photonic grating coupler 100). Optical fiber 420 outputs optical signal 415 with two independent channels in corresponding orthogonal polarizations TEO and TMO. The topside of material stack 405 where beam pattern 440 is incident is associated with two input virtual/simulation ports. Since PSGC 400 rotates the TMO polarization mode component received from optic fiber 420 to the TEO polarization mode at waveguide port 410B, each waveguide port 410A and 410B is assigned a single virtual port for its respective TEO polarization mode component. Accordingly, the loss function for PSCG 400 specifies four virtual/simulation ports while the loss function for photonic grating coupler 100 specifies just two virtual/simulation ports.

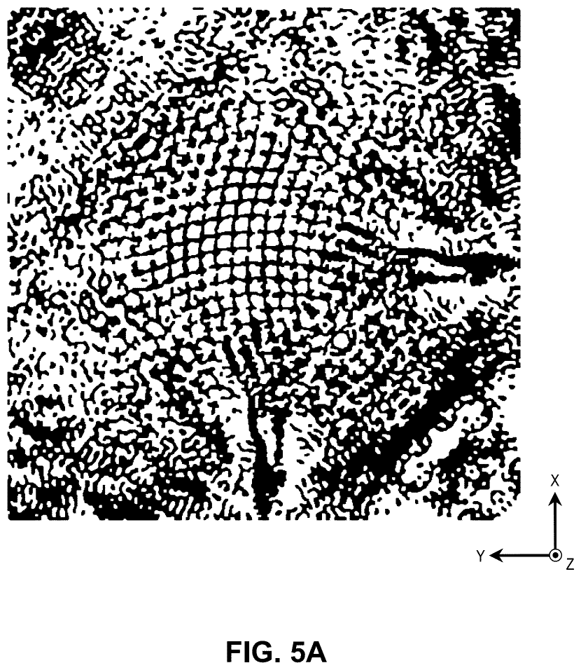

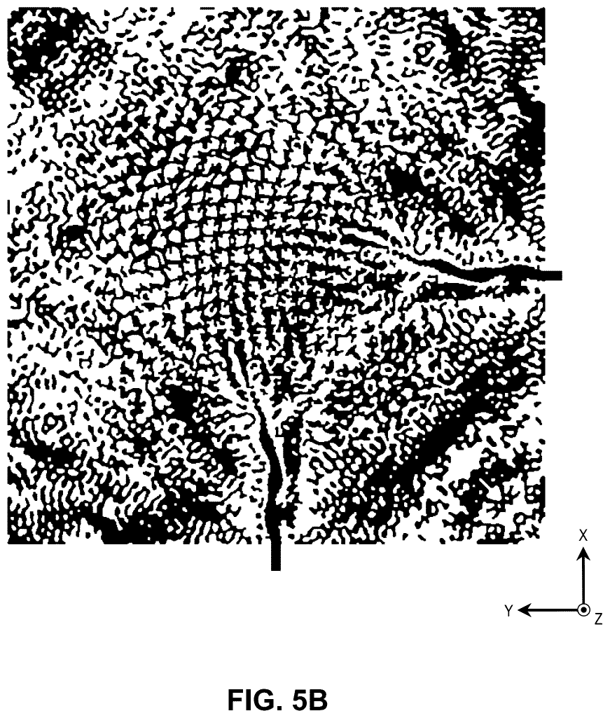

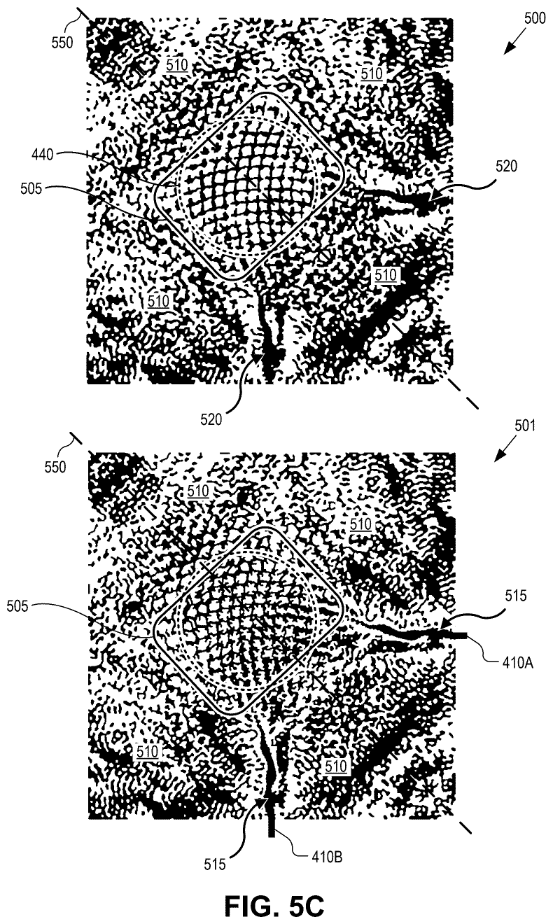

FIGS. 5A and 5B illustrate upper and lower grating patterns 500 and 501, in accordance with an embodiment of the disclosure. Upper and lower grating patterns 500 and 501 represent example grating patterns that may be formed into upper and lower design regions 406 and 407, respectively, for forming PSGC 400. Upper and lower grating patterns 500 and 501 are inversely designed patterns derived from an iterative minimization of a loss function used during the inverse design methodology. FIG. 5C illustrates upper and lower grating patterns 500 and 501 with annotations to aid discussion of the various features of these grating patterns.

The illustrated embodiment of upper and lower grating patterns 500 and 501 each include a central region 505 for aligning with the incident beam pattern 440 of optical signal 415 surrounded by a peripheral region 510. Central region 505 has a fish scale like pattern defined by two sets of concentric curve patterns that intersect each other at a normal or near-normal incidence (e.g., within 15 degrees). The fish scale like pattern forms a diffraction grating such that diffraction predominates in central region 505. Correspondingly, peripheral region 510 surrounds central region 505 and has a chaos-like pattern that is less uniform than the fish scale like pattern of central region 505. The chaos-like pattern of periphery region 510 forms a reflector where periodic Bragg reflection predominates. Irregularly shaped channels 515 and 520 are defined in diffraction grating patterns 501 and 500, respectively. Irregularly shaped channels 515 and 520 extend from central region 505 through peripheral region 510 to the edges of the respective patterns adjacent to waveguide ports 410A or 410B. The irregularly shaped channels 515 and 520 are formed of the higher index material (black colored regions) and provide beam confinement to gather the split components of optical signal 415 into their respective waveguide ports 410A and 410B.

While the upper and lower grating patterns 500 and 501 resemble each other, it is notable that the fish scale like pattern of central region 505 in lower grating pattern 501 has more irregular jagged features compared to the fish scale like pattern of upper grating pattern 500. In one embodiment, lower grating pattern 501 has a smaller minimum feature size (e.g., 80-90 nm) than upper grating pattern 500 (e.g., 100-104 nm). In one embodiment, upper grating pattern 500 is fabricated from polysilicon (black portions) and silicon oxide (white portions) while lower grating pattern 501 is fabricated from silicon (black portions) and silicon oxide (white portions). In one embodiment, upper and lower grating patterns 500 and 501 are 16 μm×12 μm, though other design region dimensions may be stipulated.

Upper and lower grating patterns 500 and 501 formed in upper and lower design regions 406 and 407 are jointly optimized during each iteration of the inverse design process using a loss function. The loss function includes component functions representing a transmission loss, a reflection loss, and a crosstalk loss between waveguide ports 410A and 410B. The component functions are themselves defined as the difference between the simulated values for a particular inverse design iteration and the desired target values (see Eq. A below). The loss function, including the component functions, are stipulated in terms of the material parameters in the upper and lower design regions, incident angle for optical signal 415, wavelengths of optical signal 415, and polarization/propagation mode and power of the output signal components reaching each waveguide port 410A or B. In illustrated embodiment, diagonal symmetry along diagonal axis 550 is set as a forced constraint during the iterative design process. However, it should be appreciated this is not a requirement and other embodiments may not have a diagonal symmetry. Similarly, FIGS. 4A and 5A-C illustrate embodiments where waveguide ports 410A, B are located on separate but adjacent sides. However, in other embodiments, waveguide ports 410A, B are constrained to reside on separate, but opposite sides or even located on the same side (e.g., see FIG. 6). Similarly, the optimal incidence angle for optical signal 415 may be selected to be normal (FIG. 6) or a selectable oblique angle (FIG. 4A).

As mentioned above, both photonic grating coupler 100 and PSGC 400 are inspired by inverse design. In particular, the two-layer grating patterns are formed from at least two materials having differing refractive indexes defined by an iterative minimization of a loss function that sums a transmission loss, a reflection loss, and a crosstalk loss. The optimization objective of the inverse design methodology may be constructed using the following loss function Loss(x),

$$Loss ( x ) = {\sum }_{λ} Transmission loss ( x , λ ) + {\sum }_{λ} Reflection loss ( x , λ ) + {\sum }_{λ} Crosstalk loss ( x , λ ) , \qquad ( Eq . A )$$

where,
Transmission loss(x,λ)=Transmission(x,λ)−target values1
Reflection loss(x,λ)=Reflection(x,λ)−target values2
Crosstalk loss(x,λ)=Crosstalk(x,λ)−target values3.

The objective is constructed in a way that the resulting structure/pattern of the upper and lower design regions is encouraged to direct the optical signal (or selected optical signal components) to the waveguide port or ports.

Inverse design operates using a design simulator (aka design model) configured with an initial design or pattern in the upper and lower design regions to perform a forward operational simulation of the initial design (e.g., using Maxwell's equations for electromagnetics). For example, the initial design could be a random pattern of silicon and silicon dioxide in the lower design region and a random pattern of polysilicon and silicon oxide in the upper design region. The output of the forward operational simulation is a simulated field response at waveguide port 110 (or waveguide ports 410A, B) in response to stimuli (e.g., optical signal 115 or 415) incident on central region 205 or 505 from a selectable angle of incidence. Specific performance parameters of this output field response may be selected as parameters of interest (e.g., power loss, wavelength, crosstalk, polarization modes, etc.) and are referred to as simulated performance parameters. The simulated performance parameters are used by the loss function to calculate a performance loss value, which may be a scalar value (e.g., mean square difference between simulated performance values and target performance values). The differentiable nature of the design model enables a backpropagation via an adjoint simulation of a performance loss error, which is the difference between the simulated output values and the desired/target performance values. The performance loss error is backpropagated through the upper and lower design regions during the adjoint simulation to generate structural gradients that represent, for example, the sensitivity of the performance loss value to changes in the structural material properties (e.g., topology of the grating patterns) of the upper and lower design regions. A program such as TensorFlow published by Google may be used to calculate the gradients. These gradients may then be used by a structural optimizer to optimize or refine the initial structural design to generate a revised structural design for the grating patterns in the upper and lower design regions. The forward and reverse simulations may then be iterated along with the structural optimization (e.g., iterative gradient descent, stochastic gradient descent, etc.) until the performance loss value falls within acceptable design criteria (referred to as saturation) and/or for a predetermined number of iterations. The above description is merely an example inverse design technique that may be used to refine or optimize the features and topology of the two-layer grating patterns in the upper and lower design regions. It is appreciated that other inverse design techniques alone, or in combination with other conventional design techniques, may also be implemented.

The inverse design techniques described above may be applied to determine the specific material combinations, feature sizes, and feature arrangement (i.e., grating patterns) to achieve the desired polarization splitting using the above loss function. At a high level, Loss(x) is a function of x, where x is a vector representing at least the structural pattern of materials having different refractive indexes within upper and lower design regions 406 and 407. In one embodiment, the target values 1, 2, and 3 correspond to the dB values listed above in connection with FIG. 3. In some embodiments, target values 1, 2, and 3 detail target values for transmission, reflection, and crosstalk losses for TEO polarization modes at waveguide ports 410A and 410B. The target values 1, 2, and 3 may be specified in terms of s-parameters. Inverse design of the upper and lower design regions 406 and 407 of PSGC 400 is the iterative minimization of Loss(x). More specifically, Loss(x) may be characterized as Loss(response, target), where:
response=Sim (p1, p2; λ0, bandwidth, θi, drc, layer_stack): simulation response,
target: targeted performance in terms of S-params of all ports (sij),
response, target∈{sij}, 0<i, j<=n where n is the number of ports,
p1, p2: geometry parameters of two Si layers. p1, p2 are the two design parameter sets that are used for optimization, others such as λ0 are hyper parameters that are not for optimization
λ0: central wavelength of interest
bandwidth: bandwidth of interest. All wavelengths within [λ0−bandwidth/2, λ0+bandwidth/2] are involved in the optimization
θi: incident angle of the input fiber
drc: design rules provided by foundries which include minimum feature sizes, etc.
layer_stack: material information of each layer (refractive index, thickness)
   Loss(response, target) is similar for both photonic grating coupler 100 and PSGC 400, except that PSGC 400 has additional ports. The ports may be specified as virtual ports VP1 and VP2 for each physical waveguide port 110, 410A, and 410B, where the dual virtual ports VP1 and VP2 correspond to the distinct channels for TEO and TMO, respectively, on each physical waveguide port. In an embodiment of PSGC 400 that rotates the TMO component of optical signal 415 to TEO at waveguide port 410B, the target values for the TMO virtual ports at both waveguide ports 410A, B are zero power.

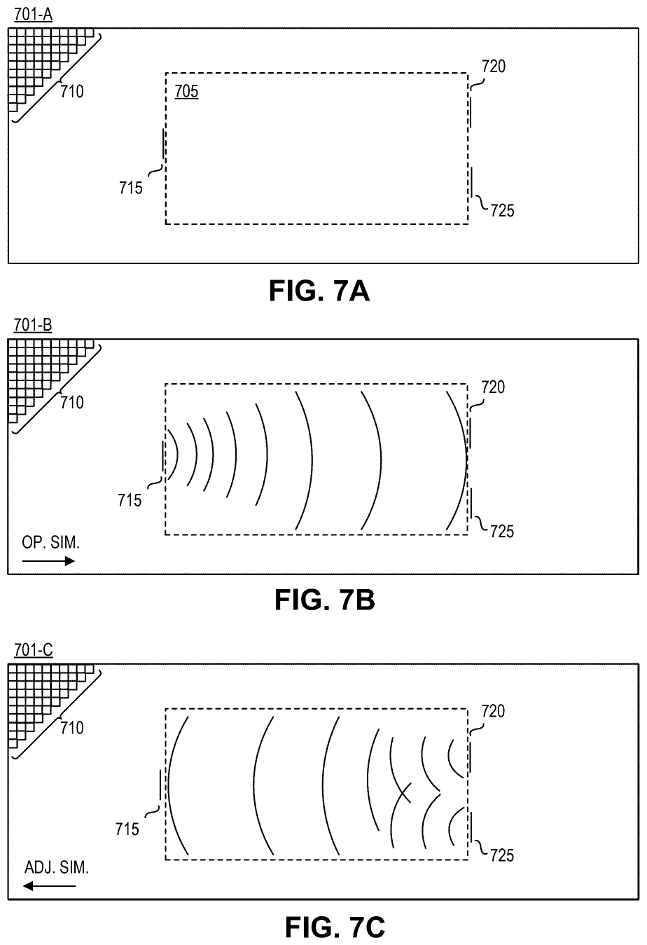

FIGS. 7A-7C illustrate an initial setup, an operational simulation, and an adjoint simulation of a simulated environment 701, respectively, for optimizing structural parameters of a physical device (e.g., photonic grating coupler 100 or PSGC 400) with a design model, in accordance with an inverse design embodiment. The simulated environment 701 and corresponding initial setup, operational simulation, adjoint simulation, and structural parameter optimization may be achieved via a physics simulator using Maxwell's equations. As illustrated in FIGS. 7A-7C, the simulated environment is represented in two-dimensions, however it is appreciated that higher dimensionality (e.g., 3-dimensional space) may also be used to describe the simulated environment 701 and the physical device. In some embodiments, the optimization of the structural parameters of the physical device illustrated in FIGS. 7A-7C may be achieved via, inter alia, simulations (e.g., time-forward and backpropagation) that utilize a finite-difference time-domain (FDTD) method to model the field responses (e.g., both electric and magnetic).

FIG. 7A illustrates an example rendering of a simulated environment 701-A describing an electromagnetic device. The simulated environment 701-A represents the simulated environment 701 at an initial time step (e.g., an initial set up) for optimizing structural parameters of the physical device. The physical device described by the simulated environment 701 may correspond to photonic grating coupler 100 or PSGC 400 having a designable region 705 (e.g., upper and lower design regions 106, 107, 406, 407) in which the structural parameters of the simulated environment may be designed, modified, or otherwise changed. The simulated environment 701 includes an excitation source 715 (e.g., a gaussian pulse, a wave, a waveguide mode response, etc. output from optic fiber 120 or 420) and incident upon the topside of the multi-layer material stacks 105 or 405 with an incident angle θ. The electrical and magnetic fields (e.g., field response) within the simulated environment 701 may change in response to the excitation source 715. The specific settings of the initial structural parameters, excitation source, performance parameters, and other metrics (i.e., initial description) for a first-principles simulation of a physical device are input before the operational simulation starts.

As illustrated, the simulated environment 701 (and subsequently the physical device under design) is described by a plurality of voxels 710, which represent individual elements of the two-dimensional (or three-dimensional) space of the simulated environment. Each of the voxels is illustrated as two-dimensional squares, however it is appreciated that the voxels may be represented as cubes or other shapes in three-dimensional space. It is appreciated that the specific shape and dimensionality of the plurality of voxels 710 may be adjusted dependent on the simulated environment 701. It is further noted that only a portion of the plurality of voxels 710 are illustrated to avoid obscuring other aspects of the simulated environment 701. Each of the plurality of voxels 710 is associated with one or more structural parameters, a field value to describe a field response, and a source value to describe the excitation source at a specific position within the simulated environment 701. The field response, for example, may correspond to a vector describing the electric and/or magnetic field at a particular time step for each of the plurality of voxels 710. More specifically, the vector may correspond to a Yee lattice that discretizes Maxwell's equations for determining the field response. In some embodiments, the field response is based, at least in part, on the structural parameters and the excitation source 715.

FIG. 7B illustrates an example operational simulation of the simulated environment 701-B at a particular time step in which the excitation source 715 is active (e.g., generating waves originating at the excitation source 715 that propagate through the simulated environment 701). As mentioned, the physical device is a photonic grating coupler, or specifically a PSGC, operating at the wavelength of interest on a particular polarization mode (e.g., TEO, TMO, etc.) and the excitation source is fiber optic 120 aligned at a specified incident angle. The operational simulation occurs over a plurality of time steps. When performing the operational simulation, changes to the field response (e.g., the field value) for each of the plurality of voxels 710 are updated in response to the excitation source 715 and based, at least in part, on the structural parameters of the physical device at each of the plurality of time steps. Similarly, in some embodiments the source value is updated for each of the plurality of voxels (e.g., in response to the electromagnetic waves from the excitation source 715 propagating through the simulated environment). It is appreciated that the operational simulation is incremental and that the field value (and source value) is updated incrementally at each time step as time moves forward for each of the plurality of time steps. It is further noted that in some embodiments, the update is an iterative process and that the update of each field and source value is based, at least in part, on the previous update of each field and source value.

When performing the operational simulation, the performance loss function, Loss(x), may be computed at each output port 720 and 725 based, at least in part, on a comparison (e.g., mean squared difference) between the field response and a desired field response at a designated time step (e.g. a final time step of the operational simulation). A performance loss value may be described in terms of a specific performance value (e.g., power in a particular polarization mode). Structural parameters may be optimized for this specific performance value.

FIG. 7C illustrates an example backpropagation of performance loss error backwards within the simulated environment 701-C describing the physical device. In one embodiment, the adjoint performance simulation injects a performance loss error at output ports 720 and 725 as a sort of reverse excitation source for stimulating a reverse field response through voxels 710 of simulated environment 701-C. The adjoint performance simulation of the performance loss error determines an influence that changes in the structural parameters of voxels 710 have on the performance loss value.

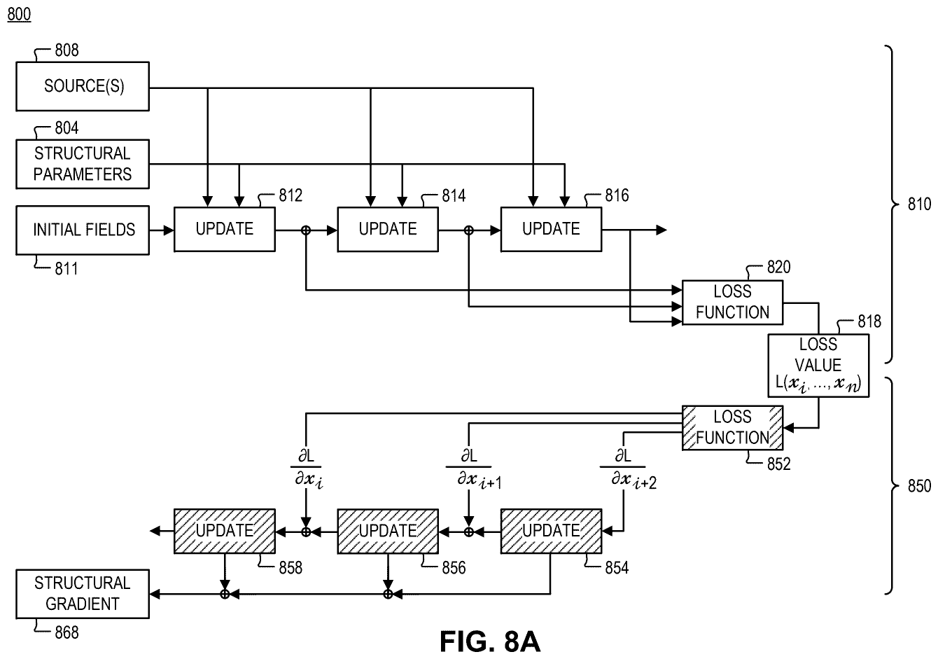

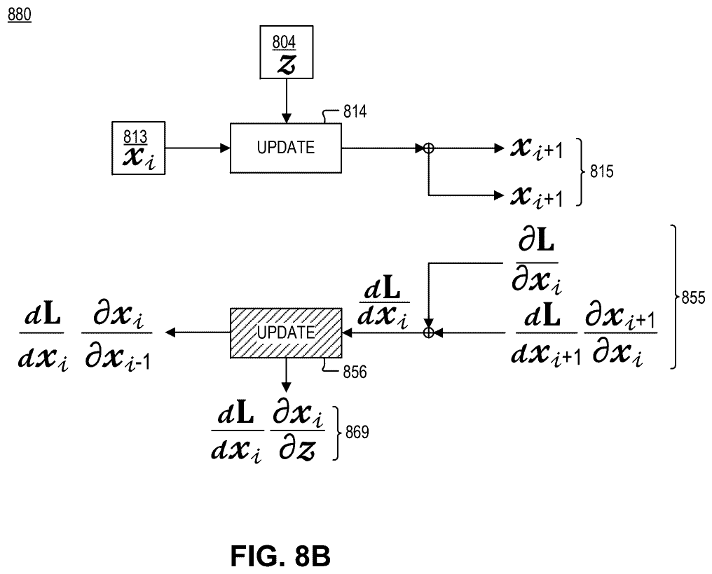

FIG. 8A is a flow chart 800 illustrating example time steps for a time-forward simulation 810 and backpropagation 850 within a simulated environment, in accordance with an embodiment of the present disclosure. Flow chart 800 is one possible implementation that a design model may use to perform a forward operational simulation 810 and backpropagation 850 of a simulated environment. In the illustrated embodiment, the forward operational simulation utilizes a FDTD method to model the field response (both electric and magnetic) at a plurality of time steps in response to an excitation source. More specifically, the time-dependent Maxwell's equations (in partial differential form) are discretized to solve for field vector components (e.g. the field response of each of the plurality of voxels 710 of the simulated environment 701 in FIGS. 7A-7C) over a plurality of time steps.

As illustrated in FIG. 8A, the flow chart 800 includes update operations for a portion of operational simulation 810 and adjoint simulation 850. Operational simulation 810 occurs over a plurality of time-steps (e.g., from an initial time step to a final time step over a pre-determined or conditional number of time steps having a specified time step size) and models changes (e.g., from the initial field values 811) in electric and magnetic fields of a plurality of voxels describing the simulated environment and/or physical device that collectively correspond to the field response. More specifically, update operations (e.g., 812, 814, and 816) are iterative and based on the field response, structural parameters 804, and one or more physical stimuli sources 808. Each update operation is succeeded by another update operation, which are representative of successive steps forward in time within the plurality of time steps. For example, update operation 814 updates the field values 813 (see, e.g., FIG. 7B) based on the field response determined from the previous update operation 812, sources 808, and the structural parameters 804. Similarly, update operation 816 updates the field values (see, e.g., FIG. 8B) based on the field response determined from update operation 814. In other words, at each time step of the operational simulation the field values (and thus field response) are updated based on the previous field response and structural parameters of the physical device. Once the final time step of the operational simulation 810 is performed, the loss value 818 may be determined (e.g., based on a pre-determined loss function 820). The loss gradients determined from block 852 may be treated as adjoint or virtual sources (e.g., physical stimuli or excitation source originating at an output region) which are backpropagated in reverse (from the final time step incrementally through the plurality of time steps until reaching the initial time step) to determine structural gradient 868.

In the illustrated embodiment, the FDTD solve (e.g., time-forward simulation 810) and backpropagation 850 problem are described pictorially, from a high-level, using only “update” and “loss” operations as well as their corresponding gradient operations. The simulation is set up initially in which the structure parameters, the excitation source, and the initial field states of the simulated environment (and electromagnetic device) are provided. As discussed previously, the field states are updated in response to the excitation source based on the structural parameters. More specifically, the update operation is given by ϕ, where xᵢ₊₁=ϕ(xᵢ, [symbol] ᵢ, z) for i=1, . . . n. Here, n corresponds to the total number of time steps (e.g., the plurality of time steps) for the time-forward simulation, xᵢ corresponds to the field response (the field value associated with the electric and magnetic fields of each of the plurality of voxels) of the simulated environment at time step i, [symbol] ᵢ corresponds to the excitation source(s) (the source value associated with the electric and magnetic fields for each of the plurality of voxels) of the simulated environment at time step i, and z corresponds to the structural parameters describing the topology and/or material properties of the electromagnetic device.

It is noted that using the FDTD method, the update operation can specifically be stated as:

$$ϕ ( {x}_{i} , {i}_{} , z ) = A ( z ) {x}_{i} + B ( z ) {i}_{} \qquad ( 1 )$$

That is to say the FDTD update is linear with respect to the field and source terms. Concretely, A(z)∈ [symbol] ^{N×N} and B(z)∈ [symbol] ^{N×N} are linear operators which depend on the structure parameters, z, and act on the fields, xᵢ, and the sources, [symbol] ᵢ, respectively. Here, it is assumed that xᵢ, [symbol] ᵢ∈ [symbol] ^{N} where N is the number of FDTD field components in the time-forward simulation. Additionally, the loss operation is given by L=(xᵢ, . . . , xₙ), which takes as input the computed fields and produces a single, real-valued scalar (e.g., the loss value) that can be reduced and/or minimized.

In terms of revising or otherwise optimizing the structural parameters of the electromagnetic device, the relevant quantity to produce is dL/dz, which is used to describe the change in the loss value with respect to a change in the structural parameters of the electromagnetic device and is denoted as the “structural gradient” illustrated in FIG. 8A.

FIG. 8B is a chart 880 illustrating the relationship between the update operation for the operational simulation and the adjoint simulation (e.g., backpropagation), in accordance with an embodiment of the present disclosure. More specifically, FIG. 8B summarizes the operational and adjoint simulation relationships that are involved in computing the structural gradient, dL/dz, which include

$$\begin{matrix}\frac{\partial L}{\partial {x}_{i}} , \frac{\partial {x}_{i + 1}}{\partial {x}_{i}} , \frac{dL}{{dx}_{i}} , and \\ \frac{\partial {x}_{i}}{\partial z} .\end{matrix}$$

The update operation 814 of the operational simulation updates the field values 813, xᵢ, of the plurality of voxels at the ith time step to the next time step (i.e., i+1 time step), which correspond to the field values 815, xᵢ₊₁. The gradients 855 are utilized to determine

$$\frac{dL}{{dx}_{i}}$$

for the backpropagation (e.g., update operation 856 backwards in time), which combined with the gradients 869 are used, at least in part, to calculate the structural gradient,

$$\frac{dL}{dz} . \frac{\partial L}{\partial {x}_{i}}$$

is the contribution of each field to the loss value, L. It is noted that this is the partial derivative, and therefore does not take into account the causal relationship of xᵢ→xᵢ₊₁. Thus,

$$\frac{\partial {x}_{i + 1}}{\partial {x}_{i}}$$

is utilized which encompasses the xᵢ→xᵢ₊₁ relationship. The loss gradient,

$$\frac{dL}{{dx}_{i}}$$

may also be used to compute the structural gradient, dL/dz, and corresponds to the total derivative of the field with respect to loss value, L. The loss gradient,

$$\frac{dL}{{dx}_{i}} ,$$

at a particular time step, i, is equal to the summation of

$$\frac{\partial L}{\partial {x}_{i}} + \frac{dL}{{dx}_{i + 1}} \frac{\partial {x}_{i + 1}}{\partial {x}_{i}} .$$

### Finally,

$$\frac{\partial {x}_{i}}{\partial z} ,$$

which corresponds to the field gradient, is used which is the contribution to dL/dz from each time/update step. dL/dz is given by:

$$\frac{dL}{dz} = {\sum }_{i} \frac{dL}{{dx}_{i}} \frac{\partial {x}_{4}}{\partial z} . \qquad ( 2 )$$

For completeness, the full form of the first time in the sum, dL/dz, is expressed as:

$$\frac{dL}{{dx}_{i}} = \frac{\partial L}{\partial {x}_{i}} + \frac{dL}{{dx}_{i + 1}} \frac{\partial {x}_{i + 1}}{\partial {x}_{i}} . \qquad ( 3 )$$

Based on the definition of ϕ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 856), which can be expressed as:

$$\frac{dL}{{dx}_{i}} = \frac{\partial L}{\partial {x}_{i}} + \frac{dL}{{dx}_{i + 1}} A ( z ) , \qquad ( 4 )$$

$$or$$

$${∇}_{{x}_{i}} L = {A ( z )}^{T} {∇}_{{x}_{i + 1}} L + \frac{\partial {L}^{T}}{\partial {x}_{i}} . \qquad ( 5 )$$

The adjoint update is the backpropagation of the loss gradients from later to earlier time steps and may be referred to as a backwards solve for

$$\frac{dL}{{dx}_{i}} .$$

The second term in the sum of the structural gradient, dL/dz, is denoted as:

$$\frac{\partial {x}_{i}}{\partial z} = \frac{d ϕ ( {x}_{i - 1} , {i - 1}_{} , z )}{dz} = \frac{dA ( z )}{dz} {x}_{i - 1} + \frac{dB ( z )}{dz} {i - 1}_{} , \qquad ( 6 )$$

for the particular form of ϕ described by equation (1).

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention,

including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A photonic grating coupler, comprising:
at least one output waveguide port; and
a multi-layer material stack disposed adjacent to the at least one output waveguide port, the multi-layer material stack including:
a first mixed material layer forming an upper inverse design region in which an upper grating pattern is disposed; and
a second mixed material layer disposed below the first mixed material layer, the second mixed material layer forming a lower inverse design region in which a lower grating pattern is disposed, wherein the at least one output waveguide port physically abuts to and extends from the second mixed material layer, and wherein the upper and lower grating patterns are structured to collectively couple an optical signal incident on the photonic grating coupler from above the first mixed material layer into the at least one output waveguide port,
wherein the upper and lower grating patterns disposed within the upper and lower inverse design regions, respectively, are jointly derived from a loss function adapted for inverse design.

2. The photonic grating coupler of claim 1, wherein the loss function optimizes the coupling efficiency for an arbitrary oblique incidence angle.

3. The photonic grating coupler of claim 1, wherein the lower grating pattern includes a smaller minimum feature size than the upper grating pattern.

4. The photonic grating coupler of claim 3, wherein the upper grating pattern within the first mixed material layer is formed from polysilicon and silicon oxide while the lower grating pattern within the second mixed material layer is formed from silicon and silicon oxide.

5. The photonic grating coupler of claim 1, wherein the multi-layer material stack further includes:
an upper cladding layer disposed on the first mixed material layer;
a substrate; and
a lower cladding layer disposed between the substrate and the second mixed material layer.

6. The photonic grating coupler of claim 1, wherein the photonic grating coupler comprises a polarization splitting grating coupler, the at least one output waveguide port comprises first and second output waveguide ports, and the upper and lower grating patterns are collectively structured to couple a first power majority of a TE polarization mode component of the optical signal into the first output waveguide port and a second power majority of a TM polarization mode component of the optical signal into the second output waveguide port.

7. The photonic grating coupler of claim 6, wherein the upper and lower grating patterns are collectively structured to rotate the TM polarization mode component to a TE polarization mode at the second output waveguide port.

8. The photonic grating coupler of claim 6, wherein the upper and lower grating patterns include:
a central region for aligning with the incident optical signal having a fish scale like pattern; and
a peripheral region surrounding the central region having a chaos pattern that is less uniform than the fish scale like pattern.

9. The photonic grating coupler of claim 8, wherein the upper and lower grating patterns include:
beam confinement regions each extending from the central region through the peripheral region to a corresponding one of the first and second output waveguide ports, wherein the beam confinement regions comprise irregular shaped channels of a highest refractive index material forming the first and second mixed material layers, respectively.

10. The photonic grating coupler of claim 8, wherein the fish scale pattern predominantly comprises a diffraction grating and the peripheral region predominantly comprises a periodic Bragg reflector.

11. The photonic grating coupler of claim 8, wherein the fish scale like pattern comprises two sets of concentric curve patterns that intersect each other at a normal or near-normal incidence.

12. The photonic grating coupler of claim 11, wherein the two sets of concentric curve patterns of the lower grating pattern are more irregularly jagged than that of the upper grating pattern.

13. The photonic grating coupler of claim 8, wherein the upper and lower grating patterns are symmetrical about a central diagonal axis.

14. A photonic polarization splitting grating coupler, comprising:
first and second waveguide ports; and
a multi-layer material stack disposed adjacent to the first and second waveguide ports, the multi-layer material stack including:
a first mixed material layer forming an upper inverse design region in which an upper grating pattern is disposed; and
a second mixed material layer disposed below the first mixed material layer, the second mixed material layer forming a lower inverse design region in which a lower grating pattern is disposed, wherein the first and second waveguide ports physically abut to and extend from the second mix material layer, and wherein the upper and lower grating patterns are structured to collectively couple a TE polarization mode of an optical signal incident on the photonic grating coupler from above the first mixed material layer into the first waveguide port and a TM polarization mode of the optical signal into the second waveguide port.

15. The photonic polarization splitting grating coupler of claim 14, wherein the lower grating pattern includes a smaller minimum feature size than the upper grating pattern.

16. The photonic polarization splitting grating coupler of claim 14, wherein the upper and lower grating patterns include:
a central region for aligning with the incident optical signal having a fish scale like pattern; and
a peripheral region surrounding the central region having a chaos pattern that is less uniform than the fish scale like pattern.

17. The photonic polarization splitting grating coupler of claim 16, wherein the upper and lower grating patterns include:
beam confinement regions each extending from the central region through the peripheral region to a corresponding one of the first and second output waveguide ports, wherein the beam confinement regions comprise irregular shaped channels of a highest refractive index material forming the first and second mixed material layers, respectively.

18. The photonic polarization splitting grating coupler of claim 16, wherein the fish scale pattern predominantly comprises a diffraction grating and the peripheral region predominantly comprises a periodic Bragg reflector.

19. The photonic polarization splitting grating coupler of claim 16, wherein the fish scale like pattern comprises two sets of concentric curve patterns that intersect each other at a normal or near-normal incidence.

20. The photonic polarization splitting grating coupler of claim 19, wherein the two sets of concentric curve patterns of the lower grating pattern are more irregularly jagged than that of the upper grating pattern.
